(19) United States
(12) Patent Application Publication
(10) Pub. No.: US 2024/0300157 A1
(43) Pub. Date: Sep. 12, 2024

(54) INJECTION MOLDING SYSTEM, INJECTION MOLDING MACHINE, AND HANDLING DEVICE

(71) Applicant: FANUC CORPORATION, Yamanashi (JP)

(72) Inventor: Nobuatsu TSUCHIYA, Yamanashi (JP)

(73) Assignee: FANUC CORPORATION, Yamanashi (JP)

(21) Appl. No.: 18/547,672

(22) PCT Filed: Apr. 28, 2021
(86) PCT No.: PCT/JP2021/017051

§ 371 Date: Aug. 23, 2023

(51) Int. Cl. B29C 45/80; B29C 45/04; B29C 45/42

(52) U.S. Cl. CPC B29C 45/80; B29C 45/0416; B29C 2045/425; B29C 2945/76083; B29C 2945/7627; B29C 2945/76658; B29C 2945/76722; B29C 2945/76872

(57) ABSTRACT

This injection molding system can correct a change in position of a movable mold due to a mold clamping force adjustment mechanism, and is provided with: an injection unit that injects a resin into a cavity formed by a movable mold and a fixed mold; a mold clamping unit that retains the movable mold and the fixed mold to be openable and closable and has a mold clamping force adjustment mechanism that adjusts mold clamping forces of the movable mold and the fixed mold; a handling unit that performs at least one of the assisting operations of an operation of extracting a molded article from the movable mold and an operation of inserting an insert component into the movable mold; and a control system that controls the injection unit, the mold clamping unit, and the handling unit. The control system has a mold position detection portion that detects the position of the movable mold during mold opening, and an operation position adjustment portion that adjusts at least one of the position of the handling unit during the assisting operation and the position of the movable mold during the mold opening according to a detection value of the mold position detection portion.

### TECHNICAL FIELD

The present invention relates to an injection molding system, an injection molding machine, and a handling device.

### BACKGROUND ART

Injection molding machines are widely used that inject molten resin into cavities defined by molds. In order to efficiently mold products using an injection molding machine, the injection molding machine may be provided additionally with a handling device that is configured by, for example, an articulated robot or the like and performs unloading work of unloading a molded product from molds or insertion work of inserting an insert component into the molds. The handling device is taught to dispose a head thereof at an appropriate position relative to the molds during mold opening.

In a case where the injection molding machine includes a movable unit that can be moved using a slide base or the like, for example, it is necessary to correct a working position of the handling device in response to movement of the movable unit of the injection molding machine. For this reason, a technique has been proposed to output position information regarding the injection molding machine to the handling device (For example, see Patent Document 1).

There is an injection molding machine having a mold clamping force adjusting mechanism that adjusts a force for clamping molds (mold clamping force) (For example, see Patent Document 2). The mold clamping force adjusting mechanism can be configured to adjust the mold clamping force by moving a reference position for movement of a movable platen that holds a movable mold.
Patent Document 1: Japanese Patent No. 6444955
Patent Document 2: Japanese Unexamined Patent Application, Publication No. 2007-261059

### DISCLOSURE OF THE INVENTION

### Problems to be Solved by the Invention

When the mold clamping force adjusting mechanism as described above is provided, the position of the movable mold can be changed during mold opening. The change in position of the movable mold due to the mold clamping force adjusting mechanism is relatively small, but depending on a shape or the like of the molded product or the insert component, a teaching point of the handling device needs to be finely adjusted according to the position of the movable mold during the mold opening. In particular, when the mold clamping force is adjusted by feedback control or the like during continuous molding, for example, there is a possibility that the handing machine cannot properly perform unloading of the molded product or insertion of the insert component due to the change in position of the movable mold during the mold opening. Therefore, there is a demand for a technique in which the mold clamping force adjusting mechanism can compensate the change in position of the movable mold.

### Means for Solving the Problems

An injection molding system according to one aspect of the present disclosure includes: an injection unit that injects resin into a cavity formed by a movable mold and a fixed mold; a mold clamping unit that holds the movable mold and the fixed mold in an openable and closable manner and includes a mold clamping force adjusting mechanism that adjusts a mold clamping force for clamping the movable mold and the fixed mold; a handling unit that performs, as auxiliary work, at least one of unloading work of unloading a molded product from the movable mold or insertion work of inserting an insert component into the movable mold; and a control system that controls the injection unit, the mold clamping unit, and the handling unit. The control system includes: a mold position detection portion that detects a position of the movable mold during mold opening; and a working position adjustment portion that adjusts, according to a value detected by the mold position detection portion, at least one of a position of the handling unit when the auxiliary work is performed or the position of the movable mold during the mold opening.

An injection molding machine according to one aspect of the present disclosure has a mold clamping force adjusting mechanism that adjusts a mold clamping force for clamping a movable mold and a fixed mold, the injection molding machine being configured to cooperate with a handling device including a handling unit that performs, as auxiliary work, at least one of unloading work of unloading a molded product from the movable mold or insertion work of inserting an insert component into the movable mold, the injection molding machine comprising an injection molding control unit including: a mold position detection portion that detects a position of the movable mold during mold opening; and a working position adjustment portion that adjusts, according to a value detected by the mold position detection portion, at least one of a position of the handling unit when the auxiliary work is performed or the position of the movable mold during the mold opening.

A handling device according to one aspect of the present disclosure includes a handling unit that performs, as auxiliary work, at least one of unloading work of unloading a molded product from a movable mold of an injection molding machine or insertion work of inserting an insert component into the movable mold, the injection molding machine having a mold clamping force adjusting mechanism that adjusts a mold clamping force for clamping the movable mold and a fixed mold, the handling device comprising a handling control unit including: a mold position detection portion that detects a position of the movable mold during mold opening; and a working position adjustment portion that adjusts, according to a value detected by the mold position detection portion, at least one of a position of the handling unit when the auxiliary work is performed or the position of the movable mold during the mold opening.

### Effects of the Invention

According to the present disclosure, it is possible to provide an injection molding system, an injection molding machine, and a handling device capable of compensating a change in position of a movable mold using a mold clamping force adjusting mechanism.

### BRIEF DESCRIPTION OF THE DRAWINGS

FIG. 1 is a schematic diagram showing a configuration of an injection molding system according to a first embodiment of the present disclosure;

FIG. 2 is a schematic diagram showing a configuration of an injection molding system according to a second embodiment of the present disclosure; and

FIG. 3 is a schematic diagram showing a configuration of an injection molding system according to a third embodiment of the present disclosure.

### PREFERRED MODE FOR CARRYING OUT THE INVENTION

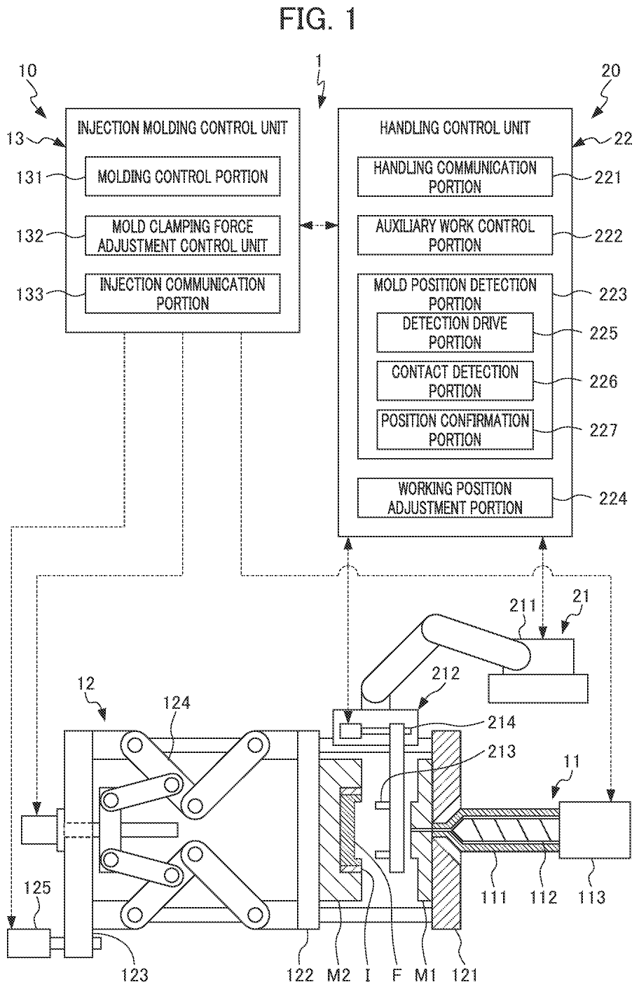

Embodiments of the present disclosure will be described below with reference to the drawings. FIG. 1 is a schematic diagram showing a configuration of an injection molding system 1 according to a first embodiment of the present disclosure.

The injection molding system 1 includes: an injection molding machine 10 that molds a molded product F by injection molding in which molten resin is injected into a cavity formed between a fixed mold M1 and a movable mold M2; and a handling device 20 that performs auxiliary works for assisting the molding of the molded product F, specifically, unloading work of unloading the molded product F from the movable mold M2 and insertion work of inserting an insert component I, which constitutes a part of the molded product F, into the movable mold M2.

The injection molding machine 10 includes an injection unit 11 that melts and ejects resin, a mold clamping unit 12 that holds the fixed mold M1 and the movable mold M2 in an openable and closable manner, and an injection molding control unit 13 that controls the injection unit 11 and the mold clamping unit 12.

The injection unit 11 includes a cylinder 111, a screw 112 housed in the cylinder 111, and an injection motor 113 that drives the screw 112 to rotate. Since such an injection unit 11 is known, a detailed description thereof will not be given.

The mold clamping unit 12 includes a stationary platen 121 that holds the fixed mold M1, a movable platen 122 that holds the movable mold M2, a rear platen 123 that defines a reference position of movement of the movable platen 122, a mold clamp driving mechanism 124 that is interposed between the movable platen 122 and the rear platen 123 and moves the movable platen 122 relative to the rear platen 123, and a mold clamping force adjusting mechanism 125 that adjusts the position of the rear platen 123 to adjust a mold clamping force that clamps the fixed mold M1 and the movable mold M2.

The stationary platen 121 is connected to a tip of the injection unit 11. The stationary platen 121 is attached with the fixed mold M1 on a side facing the movable platen 122.

The movable platen 122 is disposed movably in a direction opposite to the stationary platen 121. The movable platen 122 may be slidably disposed along a plurality of shafts connected to the stationary platen 121, for example. The movable platen 122 moves to form a mold clamping state in which the movable mold M2 is brought into close to the fixed mold M1 and a mold open state in which the movable mold M2 is separated from the fixed mold M1.

The rear platen 123 defines a reference position for movement of the movable platen 122. The rear platen 123 is disposed such that the position in a moving direction of the movable platen 122 can be finely adjusted. For this reason, the rear platen 123 can be slidably disposed along a shaft on which the movable platen 122 slides.

The mold clamp driving mechanism 124 is interposed between the movable platen 122 and the rear platen 123 and defines a distance between the movable platen 122 and the rear platen 123. The mold clamp driving mechanism 124 can be configured by a link mechanism driven by a servomotor. The mold clamp driving mechanism 124 is controlled to move the movable platen 122 with a constant stroke.

The mold clamping force adjusting mechanism 125 adjusts the position of the rear platen 123 to adjust a magnitude of a mold clamping force generated by an elastic force of the mold clamp driving mechanism 124, for example. In other words, the mold clamping force adjusting mechanism 125 reduces the mold clamping force by moving the rear platen 123 away from the stationary platen 121, and increases the mold clamping force by moving the rear platen 123 closer to the stationary platen 121.

The injection molding control unit 13 includes a molding control portion 131 that controls a cycle of forming the molded product F, a mold clamping force adjusting control portion 132 that controls the mold clamping force adjusting mechanism 125 to adjust the mold clamping force, and an injection communication portion 133 that communicates with the handling device 20 for cooperative operation. The injection molding control unit 13 can be implemented by causing a computer device having a memory, a CPU, and an input/output interface or the like to execute an appropriate program. The molding control portion 131 and the mold clamping force adjusting control portion 132 are classified according to function of the injection molding control unit 13, and may not be clearly distinguished in terms of a physical structure and a program structure.

The molding control portion 131 performs repeatedly an insertion instruction of the insert component I to the handling device 20, closing and clamping of the molds M1 and M2 by the mold clamp driving mechanism 124, an injection of resin by the injection unit 11, opening of the molds M1 and M2 by the mold clamp driving mechanism 124, and an unloading instruction of the molded product F to the handling device 20 in this order. When the molded product F is repeatedly molded, the unloading instruction of the molded product F and the insertion instruction of the insert component I in the next cycle may be combined into one instruction. Since such control of the molding cycle is the same as that in the conventional injection molding machine, a detailed description will not be given.

For example, when the movable platen 122, the rear platen 123, and the mold clamp driving mechanism 124 are thermally deformed due to a temperature transfer from the mold and thus the mold clamping force changes, the mold clamping force adjusting control portion 132 controls the mold clamping force adjusting mechanism 125 to adjust the mold clamping force during mold opening. The adjustment of the mold clamping force can be executed at a predetermined timing during continuous molding, that is, while the molding cycle is being repeatedly performed by the molding control portion 131.

The injection communication portion 133 sends an instruction signal for inserting the insert component I and an instruction signal for unloading the molded product F to the handling device 20. Further, the injection communication portion 133 receives, from the handling device 20, a confirmation signal indicating completion of insertion of the insert component I and a confirmation signal indicating completion of unloading of the molded product F. When the mold clamping force adjusting control portion 132 adjusts the mold clamping force, the injection communication portion 133 may send a signal to the handling device 20 to confirm the position of the movable mold M2 and adjust the working position for the auxiliary work.

The handling device 20 includes a handling unit 21 that performs auxiliary work and a handling control unit 22 that controls the handling unit 21. The handling device 20 itself of the present embodiment is one embodiment of the handling device according to the present disclosure, and can optimize independently a working position where the insert component I is inserted and a working position where the molded product F is unloaded.

The handling unit 21 includes a positioning mechanism 211 and a working head 212 provided at a tip of the positioning mechanism 211.

Although the positioning mechanism 211 can be a vertical articulated robot as shown, but it is not limited thereto, and may be, for example, a Cartesian coordinate robot, a SCARA robot, or a parallel link robot, or the like, or may be a short axis actuator depending on the configuration of the working head 212.

The working head 212 includes one or a plurality of holding parts 213 capable of holding the molded product F and the insert component. In addition, the working head 212 may include a reach mechanism 214 that moves the holding parts 213 in an approaching direction and a separating direction relative to the movable mold M2. The holding part 213 can be configured by a pair of finger-like gripping members for gripping the molded product F and the insert component, an engaging member capable of engaging with the molded product F and the insert component, a suction pad for sucking the molded product F and the insert component and the like. The reach mechanism 214 is configured to have a feed shaft for causing the holding part 213 to protrude and retreat toward the movable mold M2. When the reach mechanism 214 is not provided, the positioning mechanism 211 causes the working head 212 to protrude and retreat as a whole toward the movable mold M2.

The handling control unit 22 includes a handling communication portion 221 that communicates with the injection molding machine 10, an auxiliary work control portion 222 that inserts the insert component I and unloads the molded product F in response to a request from the handling device 20, a mold position detection portion 223 that detects the position of the movable mold M2 during mold opening, and a working position adjustment portion 224 that adjusts the position of the working head 212 of the handling unit 21 when the auxiliary work is performed according to the value detected by the mold position detection portion 223. In other words, in the injection molding system 1, the injection molding control unit 13 and the handling control unit 22 constitute part of a control system that controls the injection unit 11, the mold clamping unit 12, and the handling unit 21.

The handling control unit 22 can be implemented by causing a computer device having a memory, a CPU, and an input/output interface to execute an appropriate control program. Each component of the handling control unit 22 is classified according to function of the handling control unit 22, and may not be clearly distinguished in terms of a physical structure and a program structure.

The handling communication portion 221 receives the instruction signal for injecting the insert component I and the instruction signal for unloading the molded product F from the injection communication portion 133 of the injection molding machine 10, and transmits the confirmation signals to the injection molding machine 10 when the insertion of the insert component I is completed and when the unloading of the molded product F is completed, as necessary. In other words, the injection communication portion 133 and the handling communication portion 221 communicate with each other.

Upon receiving the instruction signals from the injection communication portion 133, the auxiliary work control portion 222 and the handling communication portion 221 operate the positioning mechanism 211 and the working head 212 according to a taught working program to execute the auxiliary work. Specifically, the auxiliary work control portion 222 causes the positioning mechanism 211 to perform positioning of the working head 212 at a working position taught as a position directly facing and separated by a predetermined distance from the movable mold M2, causes the holding part 213 to protrude with the positioning mechanism 211 or the reach mechanism 214, thereby inserting the insert component I or holding the molded product F, and causes the positioning mechanism 211 or the reach mechanism 214 to retreat the holding part 213, thereby removing the holding part 213 from the insert component I or unloading the molded product F held by the holding part 213 from the movable mold M2.

The mold position detection portion 223 confirms the position of the movable mold M2 at a predetermined timing when the mold is opened during the continuous molding by the molding control portion 131. The position confirmation of the movable mold M2 by the mold position detection portion 223 may be performed every cycle, or may be performed only when the mold clamping force adjusting control portion 132 adjusts the mold clamping force in order to shorten the cycle time.

The mold position detection portion 223 includes a detection drive portion 225 that brings the working head 212 into contact with the movable mold M2 or the molded product F in the movable mold M2 by predetermined operation of the handling unit 21, a contact detection portion 226 that detects the contact between the movable mold M2 or the molded product F and the working head 212 of the handling unit 21, and a position confirmation portion 227 that confirms the tip position of the handling unit 21 when the contact detection portion 226 detects the contact, that is, the position of the movable mold M2 based on the reference of the working head 212.

The detection drive portion 225 disposes the working head 212 at a position facing the movable mold M2, and then causes the working head 212 as a whole or the holding part 213 to protrude with the positioning mechanism 211 or the reach mechanism 214, thereby bringing the working head 212 or the holding part 213 into contact with the movable mold M2 or the molded product F. The position of the working head at this time may be a position offset in a direction, which is different from the moving direction of the movable mold M2, from the working position where the auxiliary work is performed such that the holding part 213 comes in contact with the outside of the cavity of the movable mold M2, for example.

When at least one of torque of a drive motor of the handling unit 21 or a change in rotation angle of the drive motor of the handling unit 21 is equal to or greater than a preset threshold value, the contact detection portion 226 can determine that the movable mold M2 or the molded product F has come into contact with the handling unit 21. The change in rotation angle of the drive motor of the handling unit 21 occurs when the tip position of the handling unit 21 is misaligned from a target position due to the contact with the movable mold M2. Further, the increase in torque of the drive motor of the handling unit 21 is caused by feedback control that attempts to eliminate the misalignment of the tip position of the handling unit 21 from the target position due to the contact with the movable mold M2. Since a posture of the handling unit 21 at the time of contact with the movable mold M2 is constant, the contact detection portion 226 may monitor a specific axis on which a fluctuation in torque or rotation angle due to the contact with the movable mold M2 becomes large, for example, only the drive motor of the reach mechanism 214 of the working head 212.

The position confirmation portion 227 confirms the tip position of the handling unit 21 based on an angular position of the drive motor of the handling unit 21 when the contact detection portion 226 detects the contact, thereby specifying the position of the movable mold M2. The position confirmation portion 227 may stop the drive motor of the handling unit 21 when the contact detection portion 226 detects the contact, and may confirm the tip position of the handling unit 21 based on the stop position of the drive motor. By stopping the drive motor, it is possible to reduce a calculation error of the position of the movable mold M2 caused by bending of the member of the handling unit 21.

In addition, the mold position detection portion 223 may confirm the position of the movable mold M2 in a manner that the positioning mechanism 211 is held in a predetermined posture and the reach mechanism 214 of the working head 212 causes the holding part 213 to protrude. In this case, the position of the movable mold M2 can be easily calculated from the rotation angle position of the drive motor of the reach mechanism 214. The position of the movable mold M2 does not necessarily have to be calculated as a coordinate position, but data capable of specifying the position of the movable mold M2, for example, a value of the rotation angle position of the drive motor may be input to the working position adjustment portion 224 without a change.

The working position adjustment portion 224 corrects the working position of the handling unit 21 such that the position of the working head 212 relative to the movable mold M2 satisfies a predetermined positional relationship when the auxiliary work is performed. In other words, the working position adjustment portion 224 corrects the position of the working head 212 positioned by the positioning mechanism 211 such that the distance between the working head 212 and the movable mold M2 becomes a preset distance. When the mold clamping force adjusting mechanism 125 adjusts the mold clamping force, the working position is corrected before the next auxiliary work is performed.

Specifically, a deviation between the position of the movable mold M2 assumed in the work program taught by the auxiliary work control portion 222 and the position detected by the mold position detection portion 223 is compensated, that is, the working position taught by the work program is corrected. By calculation of a difference between the position detected previously by the mold position detection portion 223 and the position detected newly by the mold position detection portion 223, the previously corrected working position may be further corrected.

As described above, according to the injection molding system 1, since the handling control unit 22 includes the mold position detection portion 223 and the working position adjustment portion 224, the change in position of the movable mold M2 during the mold opening can be compensated by the adjustment of the mold clamping force, and the insertion of the insert component I and the unloading of the molded product can be reliably performed.

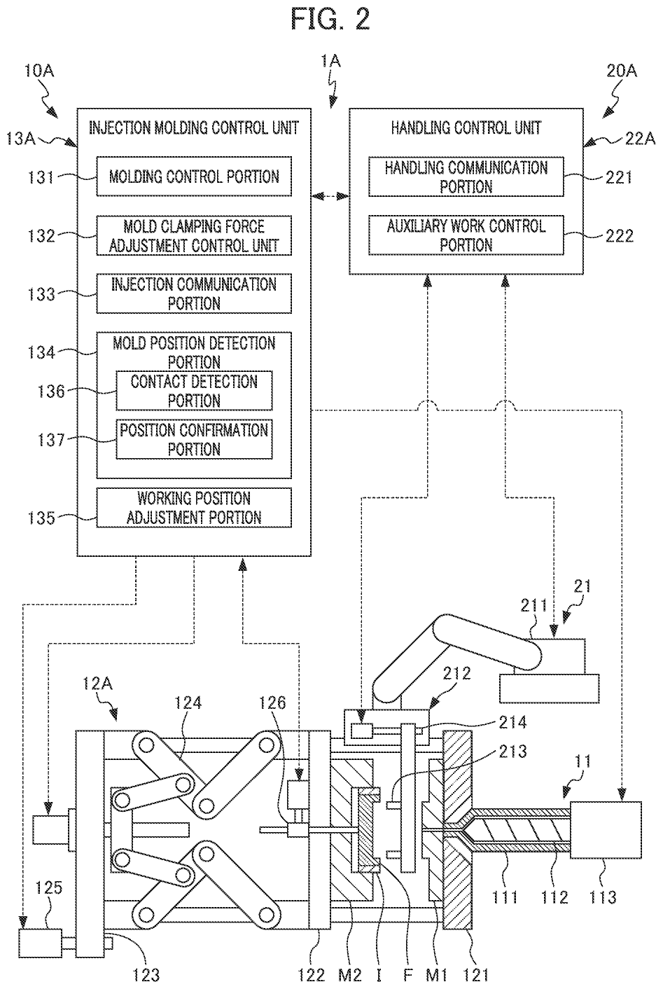

Subsequently, FIG. 2 shows an injection molding system 1A according to a second embodiment of the present disclosure. In the following description, the same components as those described in the first embodiment are denoted by the same reference numerals, and will not be repeatedly described.

The injection molding system 1A in FIG. 2 includes an injection molding machine 10A and a handling device 20A that performs auxiliary work. The injection molding machine 10A itself of the present embodiment is an embodiment of the injection molding machine according to the present disclosure, and has a function of adjusting a working position of a handling unit 21 according to adjustment of a mold clamping force.

The injection molding machine 10 includes an injection unit 11, a mold clamping unit 12A that holds a fixed mold M1 and a movable mold M2, and an injection molding control unit 13A that controls the injection unit 11 and the mold clamping unit 12A. The handling device 20A includes a handling unit 21 that performs auxiliary work and a handling control unit 22A that controls the handling unit 21.

The mold clamping unit 12A includes a stationary platen 121 that holds the fixed mold M1, a movable platen 122 that holds the movable mold M2, a rear platen 123 that defines a reference position of movement of the movable platen 122, a mold clamp driving mechanism 124 that is interposed between the movable platen 122 and the rear platen 123 and moves the movable platen 122 relative to the rear platen 123, a mold clamping force adjusting mechanism 125 that adjusts the position of the rear platen 123 to adjust a mold clamping force that clamps the fixed mold M1 and the movable mold M2, and an ejector 126 that pushes out a molded product F from a cavity.

The ejector 126 can be configured in which a pusher protrudes or retreats toward the fixed mold M1 according to a rotation angle position of a drive motor. The pusher of the ejector 126 is preferably able to protrude until coming into contact with a working head 212 disposed at a working position.

The injection molding control unit 13 includes a molding control portion 131 that controls a cycle of forming the molded product E, a mold clamping force adjusting control portion 132 that controls the mold clamping force adjusting mechanism 125 to adjust the mold clamping force, a mold position detection portion 134 that detects a position of the movable mold M2 during mold opening, a working position adjustment portion 135 that adjusts a position of the working head 212 of the handling unit 21 when the auxiliary work is performed according to the value detected by the mold position detection portion 134, and an injection communication portion 133 that communicates with the handling device 20 for cooperative operation.

The mold position detection portion 134 includes a contact detection portion 136 that detects contact between the ejector 126 or the molded product F in the movable mold M2 pushed out by the ejector 126 and the handling unit 21, and a position confirmation portion 137 that confirms a tip position of the ejector 126 when the contact detection portion 136 detects the contact.

The contact detection portion 136 determines that the pusher comes into contact with the working head 212 of the handing unit 21 disposed at a predetermined position directly or via the molded product F when torque of the drive motor of the ejector 126 increases.

The position confirmation portion 137 confirms the tip position of the pusher of the ejector 126, that is, the amount of protrusion of the pusher, based on the rotation angle position of a drive motor of the ejector 126 when the contact detection portion 136 detects the contact or the rotation angle position of the drive motor of the ejector 126 that is stopped when the contact detection portion 136 detects the contact. Thus, a relative position of a drive part of the ejector 126 and the movable mold M2 held so as not to move is calculated relative to the working head 212 of the handling unit 21, which contacts with the pusher directly or via the molded product F having a certain thickness. Since it is assumed that the working head 212 is disposed at a fixed position, the position of the movable mold M2 is calculated backward.

The working position adjustment portion 135 adjusts the working position of the handling device 20, that is, the position of the working head 212 positioned by the positioning mechanism 211 such that the position of the working head 212 relative to the movable mold M2 satisfies a predetermined positional relationship, that is, the distance between the working head 212 and the movable mold M2 satisfies a preset distance when the auxiliary work is performed. The working position adjustment portion 135 transmits the adjusted working position to the handling control unit 22A via the injection communication portion 133.

The handling control unit 22A includes a handling communication portion 221 that communicates with the injection molding machine 10 and an auxiliary work control portion 222 that inserts an insert component I and unloads the molded product F in response to a request from the handling device 20. In other words, the handling control unit 22A does not have function of detecting the contact of the handling unit 21 and a function of calculating the position of the movable mold M2. Therefore, the handling control unit 22A sets the working position using the injection molding control unit 13 as described above.

As described above, according to the injection molding system 1A in FIG. 2, since the injection molding machine 10A includes the mold position detection portion 134 and the working position adjustment portion 135, the change in position of the movable mold M2 during the mold opening can be compensated by the adjustment of the mold clamping force, and the insertion of the insert component I and the unloading of the molded product can be reliably performed.

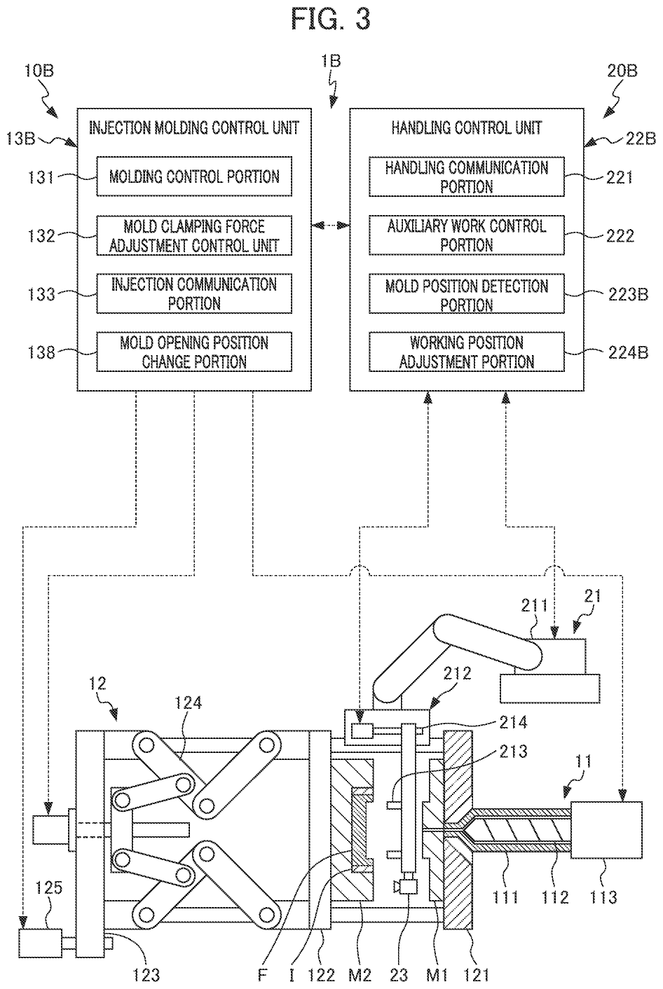

Further, FIG. 3 shows an injection molding system 1B according to a third embodiment of the present disclosure. The injection molding system 1B in FIG. 3 includes an injection molding machine 10B and a handling device 20B that performs auxiliary work.

The injection molding machine 10B includes an injection unit 11, a mold clamping unit 12 that holds a fixed mold M1 and a movable mold M2, and an injection molding control unit 13B that controls the injection unit 11 and the mold clamping unit 12.

The injection molding control unit 13B includes a molding control portion 131, a mold clamping force adjusting control portion 132, an injection communication portion 133, and a mold opening position change portion 138 that changes a position of the movable mold M2 during mold opening.

The mold opening position change portion 138 changes a position of the movable mold M2 during mold opening by setting a rotation angle position of a servomotor of the mold clamp driving mechanism 124 during the mold opening. In other words, the mold opening position change portion 138 changes a movement stroke of the movable platen 122 by the mold clamp driving mechanism 124. The rotation angle position of the servomotor during the mold opening is instructed from the handling device 20B.

The handling device 20B includes a handling unit 21 that performs auxiliary work, a distance information detector 23 attached to the working head 212 of the handling unit 21, and a handling control unit 22B that controls the handling unit 21 and the distance information detector 23.

The distance information detector 23 includes at least one of a camera or a distance sensor. In other words, the distance information detector 23 may be a camera that acquires image information capable of calculating a distance, or a sensor capable of directly measuring a distance.

The handling control unit 22B includes a handling communication portion 221, an auxiliary work control portion 222, a mold position detection portion 223B that specifies the position of the movable mold M2 based on a value detected by the distance information detector 23, and a working position adjustment portion 224B that adjusts the position of the movable mold M2 during the mold opening based on a value detected by the mold position detection portion 223B.

The mold position detection portion 223B calculates the position of the movable mold M2 based on the value detected by the distance information detector 23 in a state where the working head 212 is disposed at the working position.

The working position adjustment portion 224B calculates the rotation angle position of the servomotor of the mold clamp driving mechanism 124 during the mold opening such that the value detected by the distance information detector 23 matches a preset setting value, and corrects the setting value of the rotation angle position of the servomotor of the mold clamp driving mechanism 124 of the mold opening position change portion 138 via the handling communication portion 221.

In the injection molding system 1B shown in FIG. 3, it is possible to detect the position of the movable mold M2 without bringing the handling unit 21 into contact with the movable mold M2, and to compensate the change in position of the movable mold M2 during the mold opening by the adjustment of the mold clamping force.

Although the embodiments of the present disclosure have been described above, the present invention is not limited to the above-described embodiments. Moreover, the effects described in the above-described embodiments are merely enumerations of the most suitable effects arising from the present invention, and the effects of the present invention are not limited to those described in the above-described embodiments.

As an example, the injection molding system according to the present disclosure may control the injection unit, the mold clamping unit, and the handling unit using a control system including a single control device. In the injection molding system according to the present disclosure, one of the injection molding control unit and the handling control unit may include the mold position detection portion, and the other may include the working position adjustment portion.

In the injection molding system according to the present disclosure, the contact detection portion may detect the contact of the handling unit with the movable mold or the molded product using a sensor that detects an external force acting on the handling unit due to distortion of a member of the handling unit for example. Further, the handling unit of the injection molding system according to the present disclosure may include a dedicated contact portion, such as a protrusion, which is brought into contact with the movable mold only when the position of the movable mold is confirmed.

### EXPLANATION OF REFERENCE NUMERALS

1: injection molding system
10, 10A, 10B: injection molding machine
11: injection unit
111: cylinder
112: screw
113: injection motor
12, 12A: mold clamping unit
121: stationary platen
122: movable platen
123: rear platen
124: mold clamp driving mechanism
125: mold clamping force adjusting mechanism
126: ejector
13, 13A, 13B: injection molding control unit
131: molding control portion
132: mold clamping force adjusting control portion
133: injection communication portion
134: mold position detection portion
135: working position adjustment portion
136: contact detection portion
137: position confirmation portion
138: mold opening position change portion
20, 20A, 20B: handling device
21: handling unit
211: positioning mechanism
212: working head
213: holding part
214: reach mechanism
22, 22A, 22B: handling control unit
221: handling communication portion
222: auxiliary work control portion
223: mold position detection portion
224, 224B: working position adjustment portion
225: detection drive portion
226: contact detection portion
227: position confirmation portion
23: distance information detector
F: molded product
I: insert component
M1: fixed mold
M2: movable mold

1. An injection molding system comprising:
an injection unit that injects resin into a cavity formed by a movable mold and a fixed mold;
a mold clamping unit that holds the movable mold and the fixed mold in an openable and closable manner and includes a mold clamping force adjusting mechanism that adjusts a mold clamping force for clamping the movable mold and the fixed mold;
a handling unit that performs, as auxiliary work, at least one of unloading work of unloading a molded product from the movable mold or insertion work of inserting an insert component into the movable mold; and
a control system that controls the injection unit, the mold clamping unit, and the handling unit,
the control system including:
a mold position detection portion that detects a position of the movable mold during mold opening; and
a working position adjustment portion that adjusts, according to a value detected by the mold position detection portion, at least one of a position of the handling unit when the auxiliary work is performed or the position of the movable mold during the mold opening.

2. The injection molding system according to claim 1,
wherein the control system includes
an injection molding control unit that controls the injection unit and the mold clamping unit, and
a handling control unit that controls the handling unit, and
wherein the injection molding control unit and the handling control unit include communication portions that communicate with each other, and transmit the value detected by the mold position detection portion or the position adjusted by the working position adjustment portion from one to another.

3. The injection molding system according to claim 1,
wherein the mold clamping force adjusting mechanism adjusts the mold clamping forces during continuous molding.

4. The injection molding system according to claim 1,
wherein the mold position detection portion includes at least one of a camera or a distance sensor.

5. The injection molding system according to claim 1,
wherein the mold position detection portion includes
a contact detection portion that detects contact of the handling unit with the movable mold, an ejector that pushes out the molded product from the movable mold, or the molded product in the movable mold, and
a position confirmation portion that confirms a tip position of at least one of the ejector or the handling unit when the contact detection portion detects the contact.

6. The injection molding system according to claim 5,
wherein, when at least one of torque of a drive motor of the ejector or a drive motor of the handling unit, a change in rotation angle of the drive motor of the handling unit, or a value detected by a sensor that detects an external force acting on the handling unit is equal to or greater than a preset threshold value, the contact detection portion determines that the movable mold, the ejector, or the molded product has come into contact with the handling unit.

7. The injection molding system according to claim 5,
wherein the position confirmation portion confirms the tip position based on a rotation angle position of a drive motor of the ejector or a drive motor of the handling unit.

8. The injection molding system according to claim 7,
wherein the position confirmation portion stops the drive motor of the ejector or the drive motor of the handling unit when the contact is detected, and confirms the tip position based on a stop position of the drive motor of the ejector or the drive motor of the handling unit.

9. An injection molding machine having a mold clamping force adjusting mechanism that adjusts a mold clamping force for clamping a movable mold and a fixed mold, the injection molding machine being configured to cooperate with a handling device including a handling unit that performs, as auxiliary work, at least one of unloading work of unloading a molded product from the movable mold or insertion work of inserting an insert component into the movable mold, the injection molding machine comprising an injection molding control unit including:
a mold position detection portion that detects a position of the movable mold during mold opening; and
a working position adjustment portion that adjusts, according to a value detected by the mold position detection portion, at least one of a position of the handling unit when the auxiliary work is performed or the position of the movable mold during the mold opening.

10. A handling device including a handling unit that performs, as auxiliary work, at least one of unloading work of unloading a molded product from a movable mold of an injection molding machine or insertion work of inserting an insert component into the movable mold, the injection molding machine having a mold clamping force adjusting mechanism that adjusts a mold clamping force for clamping the movable mold and a fixed mold, the handling device comprising a handling control unit including:
a mold position detection portion that detects a position of the movable mold during mold opening; and
a working position adjustment portion that adjusts, according to a value detected by the mold position detection portion, at least one of a position of the handling unit when the auxiliary work is performed or the position of the movable mold during the mold opening.
